(19) United States
(12) Patent Application Publication
(10) Pub. No.: US 2026/0202883 A1
(43) Pub. Date: Jul. 16, 2026

(54) INFORMATION HANDLING SYSTEM WITH A BUNDLED WIRE TYPE CABLE TENSIONER

(71) Applicant: DELL PRODUCTS L.P., Round Rock, TX (US)

(72) Inventors: Timothy Radloff, Austin, TX (US); Allen B. McKittrick, Cedar Park, TX (US)

(21) Appl. No.: 19/024,505

(22) Filed: Jan. 16, 2025

(51) Int. Cl. G06F 1/16

(52) U.S. Cl. CPC G06F 1/1683; G06F 1/1616

(57) ABSTRACT

An information handling system includes top and bottom portions, a cable, and a set of cable tension components. The top portion includes a display device. The bottom portion is coupled to the top portion and includes a processor and a base assembly. The cable electrically couples the display device to the processor. The set of cable tension components are physically coupled to the base assembly and includes a mechanical component and a spring. The mechanical component is securely attached to the cable. The spring exerts a force on the mechanical component. When the top portion is in a closed position, the force from the spring on the mechanical component biases the cable toward a retracted position.

### FIELD OF THE DISCLOSURE

The present disclosure generally relates to information handling systems, and more particularly relates to an information handling system with a bundled wire type cable tensioner.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes top and bottom portions, a cable, and a set of cable tension components. The top portion includes a display device. The bottom portion is coupled to the top portion and includes a processor and a base assembly. The cable electrically couples the display device to the processor. The set of cable tension components are physically coupled to the base assembly and includes a mechanical component and a spring. The mechanical component is securely attached to the cable. The spring exerts a force on the mechanical component. When the top portion is in a closed position, the force from the spring on the mechanical component biases the cable toward a retracted position.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a diagram of an information handling system according to at least one embodiment of the present disclosure;

FIG. 2 is a diagram of a portion of an information handling system according to at least one embodiment of the present disclosure;

FIGS. 3A-D are side views of a portion of an information handling system as a top portion transitions from an open position to a closed position according to at least one embodiment of the present disclosure;

FIG. 4 is a diagram of a portion of an information handling system with a cable in a retracted position according to at least one embodiment of the present disclosure;

FIG. 5 is a diagram of a portion of an information handling system with a cable in an extended position according to at least one embodiment of the present disclosure;

FIG. 6 is a diagram of a portion of an information handling system with a set of tension components including a retention mechanism in an extended position according to at least one embodiment of the present disclosure;

FIG. 7A is a diagram of a portion of an information handling system with an exploded view of a set of tension components according to at least one embodiment of the present disclosure;

FIG. 7B is a diagram of a portion of an information handling system with a cable in a retracted position according to at least one embodiment of the present disclosure; and

FIG. 8 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

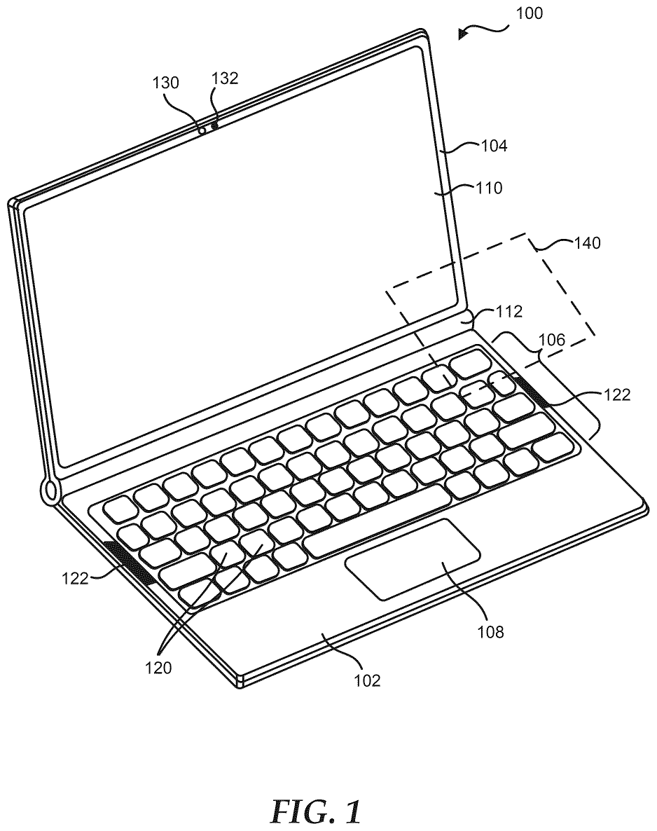

FIG. 1 illustrates an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a base portion 102 and a top portion 104. Base portion 102 includes a keyboard 106 and a touchpad 108, and top portion 104 includes a display device 110. In an example, touchpad 108 may be any suitable pointing device. Base portion 102 is connected top portion 104 via a mechanism 112, such as one or more hinges. Keyboard 106 includes multiple keys 120. Base portion 102 further includes speakers 122. Top portion 104 includes a camera 130 and a microphone 132. Information handling system 100 further includes a processor 140, an ultrasound processor 142, and a vision processor 144. Information handling system 100 may include additional components without varying from the scope of the disclosure.

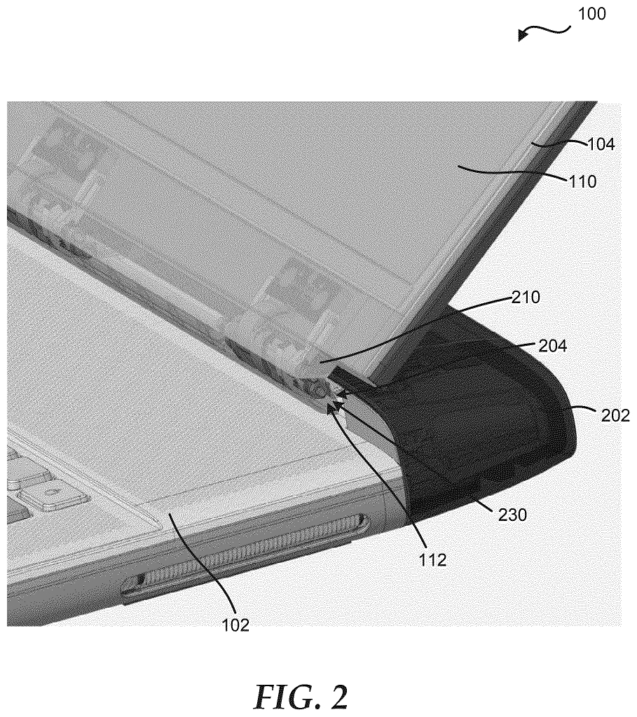

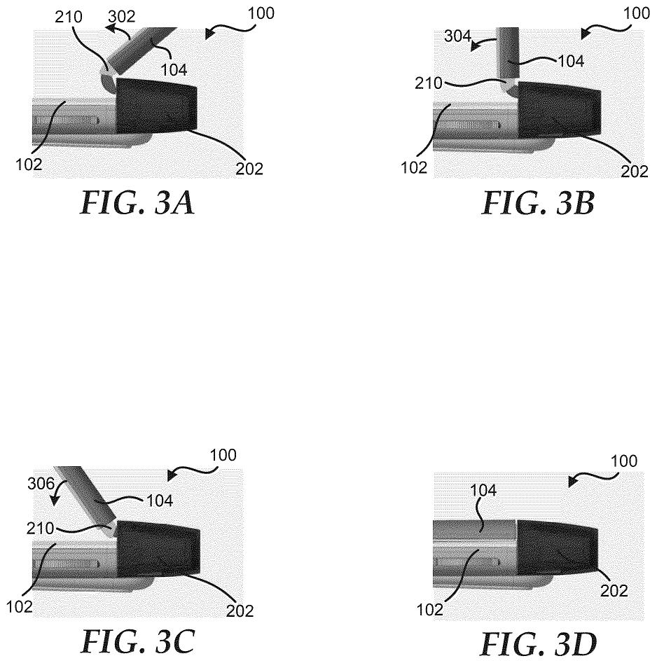

When the information handling system 100 includes a 2-in-1 device, mechanism 112 may enable the top portion 104 to be connected to bottom portion 102 for use as a laptop device and may enable the top portion 104 to be detached from bottom portion 102 to enable the top portion 104 to be used as a tablet information handling system. Display device 110 may include one or more light emitting devices, such as, for example, light emitting diodes (LEDs), organic LED (OLED), liquid crystal display (LCD), another type of light emitting device, or any combination thereof. A portion 140 of information handling system 100 will be described in greater detail with respect to FIGS. 2 and 3A-D below.

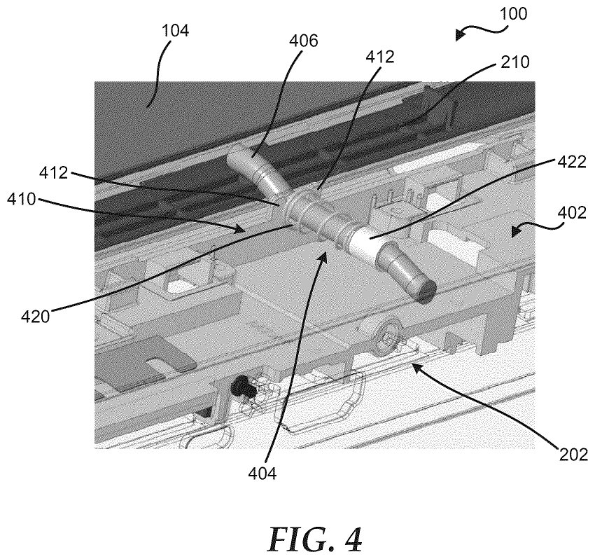

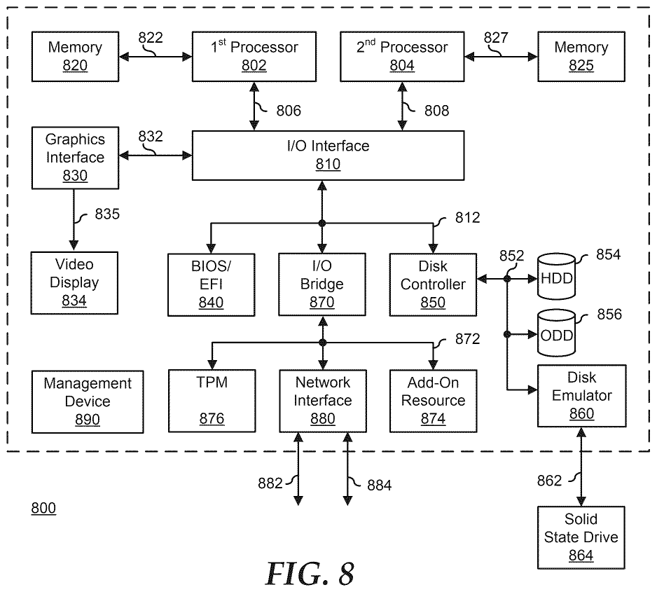

FIG. 2 illustrates a portion of information handling system 100 according to at least one embodiment of the present disclosure. Base portion 102 includes a rear section 202, which in turn includes a cavity 204. Top portion 104 includes a hinge up component 210 that is attached to hinge 112. Information handling system 100 further includes a cable, such as cable 406 in FIG. 4, to electrically couple display device 110 to components within base portion 102, such as one or more of the components illustrated and described with respect to FIG. 8 below. Information handling system 100 may include additional components without varying from the scope of this disclosure.

In an example, rear section 202 may house different components for routing cables within base portion 102. For example, rear section 202 may include a base assembly, such as base assembly 402 in FIG. 4, to route a cable, such as cable 406 in FIG. 4, from display device 110 to components within base portion 102. Rear section 202 may also be a thermal shelf, such that components within the rear section provide thermal cooling to the components of base section 102.

In certain examples, hinge 112 may have any suitable design. For example, hinge 112 may have a hidden hinge design. In this example, hinge up component 210 of top portion 104 may block or hide parts of hinge 112. Hinge up component 210 may extend away from the bottom surface of top portion 104 and cover different portions of hinge 112 when the top portion is in an open position. When top portion 104 is in a closed position, as illustrated in FIG. 3D, hinge up component 210 may be inserted into cavity 204 of rear portion 202.

In an example, hinge 112 may not have a physical component, such as a rod or pin, to provide or define a rotational axis of the hinge. However, hinge 112 may have a virtual rotation point or axis 230. In this example, while top portion 104 transitions between the open position and the closed position, the top portion may rotate around rotation point or axis 230 without a physical component at the rotation axis. In an example, the portion of cable, such as cable 406 in FIG. 4, in hinge up component 210 may bend around rotation point or axis 230.

During the transition of top portion 104 between the open position and the closed position, a cable, such as cable 406 in FIG. 4, may transition between an extended position and a retracted position. In certain examples, the length of cable 200 needed between display device 110 and the components within base portion 102 may differ based on whether top portion 104 is in the open position or the closed position. The need for a cable, such as cable 406 in FIG. 4, to be longer when top portion 104 is in the open position as compared to when the top portion is in the closed position may cause slack in the cable when the top portion is in the closed position. This slack may cause a cable, such as cable 406 in FIG. 4, to be pinched or otherwise damaged during the transition of top portion 104 from the open position to the closed position.

The risk of a cable, such as cable 406 in FIG. 4, being pinched or damaged may be greatly reduced or eliminated by a set of tension components, such as tension components 404 of FIG. 4, controlling the amount of the cable within hinge 112 as top portion 104 rotates between the open position and the closed position. In an example, the set of tension components may retract a cable, such as cable 406 in FIG. 4, as top portion 104 closes and ensure that the cable is managed as telescoping portions of hinge cap structure 112 close. This set of tension components may avoid the cable from pinching which might damage the cable or interfere with closing top portion 104.

FIGS. 3A-D illustrate a portion of information handling system 100 as top portion 104 transitions from the open position to the closed position according to at least one embodiment of the present disclosure. During the sequence of top portion 104 transitioning from the open position, as illustrated in FIG. 3A, to the closed position, as illustrated in FIG. 3D, the location of the top portion with respect to base portion 102 and rear section 202 changes as illustrated in FIGS. 3A, 3B, 3C, and 3D.

Referring to FIG. 3A, top portion 104 is in the open position, such that the top portion is at any suitable angle with respect to base portion 102 and rear section 202. In an example, this angle may be set by an individual using information handling system 100 so that the display device in top portion 102 may be viewed by the individual. When top portion 102 is in the open position, hinge up component 210 is outside of rear section 202 and a cable, such as cable 406 in FIG. 4, is bent around a rotation point or axis of the hinge of information handling system 100. In this position of top portion 104, the amount of a cable, such as cable 406 in FIG. 4, extending between rear portion 202 and hinge up component 210 should be enough to allow the cable to extend between the components in base portion 102 and the attachment point in the top portion without a lot of extra amount of cable being located outside of the rear section. When the individual wants to close information handling system 100, the individual may exert a force on top portion 104 and this force may cause the top portion to rotate in the direction of arrow 302.

Referring to FIG. 3B, top portion 104 is in an intermediate position between the open position and the closed position. When top portion 102 is in this intermediate position, hinge up component 210 may still be outside of rear section 202 and a cable, such as cable 406 in FIG. 4, is bent around a rotation point or axis of the hinge of information handling system 100. In this position of top portion 104, the amount of a cable, such as cable 406 in FIG. 4, extending between rear portion 202 and hinge up component 210 will be less than the amount when the top portion is in the open position. In an example, the amount of a cable, such as cable 406 in FIG. 4, outside of rear section 202 should be enough to allow the cable to extend between the components in base portion 102 and the attachment point in top portion 104 without a lot of extra amount of cable being located outside of the rear section.

As top portion 104 transitions from the open position to the current intermediate position, a cable, such as cable 406 in FIG. 4, may retract within rear portion 202 to maintain a proper amount of the cable being located outside of the rear portion. In an example, the proper amount of a cable, such as cable 406 in FIG. 4, may be any suitable amount that reduces the chance or prevents the cable from being pinched or damaged by top portion 104. As the individual continues to close information handling system 100, the individual may continue to exert the force on top portion 104 and this force may cause the top portion to rotate in the direction of arrow 304.

Referring to FIG. 3C, top portion 104 is in another intermediate position between the open position and the closed position. When top portion 102 is in this intermediate position, hinge up component 210 may still be outside of rear section 202 and a cable, such as cable 406 in FIG. 4, is bent around a rotation point or axis of the hinge of information handling system 100. In this position of top portion 104, the amount of a cable, such as cable 406 in FIG. 4, extending between rear portion 202 and hinge up component 210 will be less than the amount when the top portion is in both the open position and the other intermediate position. In an example, the amount of a cable, such as cable 406 in FIG. 4, outside of rear section 202 should be enough to allow the cable to extend between the components in base portion 102 and the attachment point in top portion 104 without a lot of extra amount of cable being located outside of the rear section.

As top portion 104 transitions from the previous intermediate position to the current intermediate position, a cable, such as cable 406 in FIG. 4, may retract within rear portion 202 to maintain a proper amount of the cable being located outside of the rear portion. In an example, the proper amount of a cable, such as cable 406 in FIG. 4, may be any suitable amount that reduces the chance or prevents the cable from being pinched or damaged by top portion 104. As the individual continues to close information handling system 100, the individual may continue to exert the force on top portion 104 and this force may cause the top portion to rotate in the direction of arrow 306.

Referring to FIG. 3D, top portion 104 is in the closed position. When top portion 102 is in closed position, hinge up component 210 may located inside rear section 202, such as cavity 204 in FIG. 2. In this position of top portion 104, a cable, such as cable 406 in FIG. 4, may be in a retracted position within rear portion 202. In an example, the amount of a cable, such as cable 406 in FIG. 4, between rear section 202 and the hinge up component 210 should be enough to allow the cable to extend between the components in base portion 102 and the attachment point in top portion 104 without a lot of extra amount of cable being located between the rear portion and the hinge up component.

When top portion 104 is in the closed position, a cable, such as cable 406 in FIG. 4, may retract to a retracted position within rear portion 202 to maintain a proper amount of the cable being located between the rear portion and the hinge up component. In an example, the proper amount of a cable, such as cable 406 in FIG. 4, may be any suitable amount that reduces the chance or prevents the cable from being pinched or damaged by top portion 104.

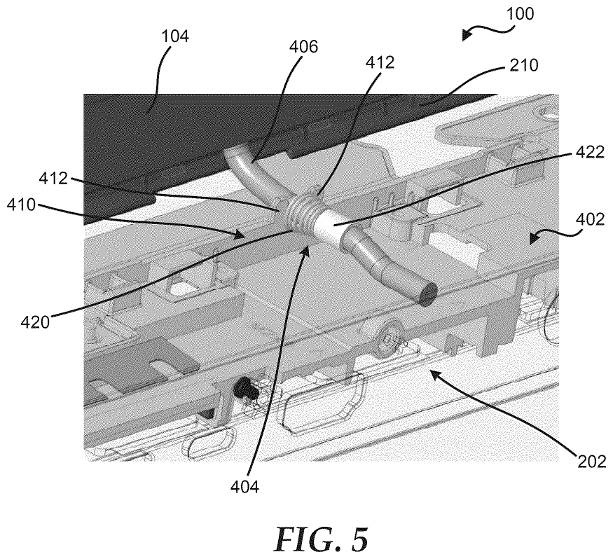

FIGS. 4 and 5 illustrate a portion of information handling system 100 according to at least one embodiment of the present disclosure. In FIGS. 4 and 5, the surface of rear portion 202 and a section of a back surface of top portion 104 are removed to show the components within these areas. Information handling system 100 includes a base assembly 402, a set of tension components 404, hinge up component 210, and cable 406. Base assembly 402 includes a wall 410 and tabs 412 extending away from the top edge of the wall. Set of tension components 404 includes a spring 420 and a mechanical component 422. In the embodiment of FIGS. 4 and 5, mechanical components 422 may be a collar or similar device. In an example, cable 406 may be any suitable communication cable including, but not limited to, wire-type cables for electronic data processing (eDP), a camera, or the like. This area of information handling system 100 may include additional components without varying from the scope of this disclosure.

Referring to FIG. 4, spring 420 of set of tension components 404 may be a compression spring, such that the default or resting position of the spring is to be extended as shown in FIG. 4. Based on the structure of spring 420, the spring may provide a retraction force over the required length of travel of cable 406. Spring 420 is positioned between wall 410 and mechanical component 422 with cable 406 extending through the middle of the spring. In an example, mechanical component 422 may be securely attached to cable 406. Mechanical component 422 may be attached to cable 406 in a particular location that enables spring 420 to exert a force on the cable, through the mechanical component, and bias the cable toward the retracted position.

In an example, cable 406 may be located on top of wall 410 and between tabs 412. This location of cable 406 with respect to wall 410 of base assembly 402 may enable the cable to slide along the wall while the cable transitions between the retracted position and the extended position. Cable 406 may also extend along hinge up component 210 and be inserted into top portion 104. When cable 406 is in the retracted position, as shown in FIG. 4, a minimal amount of the cable is located between wall 410 and hinge up component 210. In an example, this minimal amount of cable 406 may prevent the cable from being pinched between hinge up component 210 and the components of rear section 202 when top portion 102 is in the closed position.

Referring to FIG. 5, cable 406 is in the extended position. When cable 406 is in the extended position, top portion 104 may exert a force on the cable to pull one end of cable away from wall 410 of base assembly 402. As cable 406 is pulled by top portion 104, mechanical component 422 may be pulled toward wall 410. In an example, the force exerted on cable 406 by top portion 104 should be greater than the force exerted on the cable by spring 420 so that mechanical component 422 may be pulled toward wall 410. The force exerted by top portion 104 may cause spring 420 to compress as shown in FIG. 5.

In an example, the location of mechanical component 422 may enable cable 406 to extend a proper amount from the retracted position to the extended position. This proper amount may be any suitable amount that enables top portion 104 to be placed in the open position but prevents cable 406 from sagging towards hinge up component 210. In an example, this amount of cable 406 being extended may prevent the cable from being pinched when top portion 102 is closed.

In certain examples, as top portion 104 rotates or transitions from the open position to the closed position, spring 420 may exert a force on cable 406 via mechanical component 422. This force exerted by spring 420 on cable 406 may ensure that the cable is maintained in a tight state, such that the cable does not sag while top portion 104 transitions from the open position to the closed position. In an example, the force exerted by spring 420 may prevent cable 406 from being pinched or otherwise damaged between hinge up component 210 and base assembly 402.

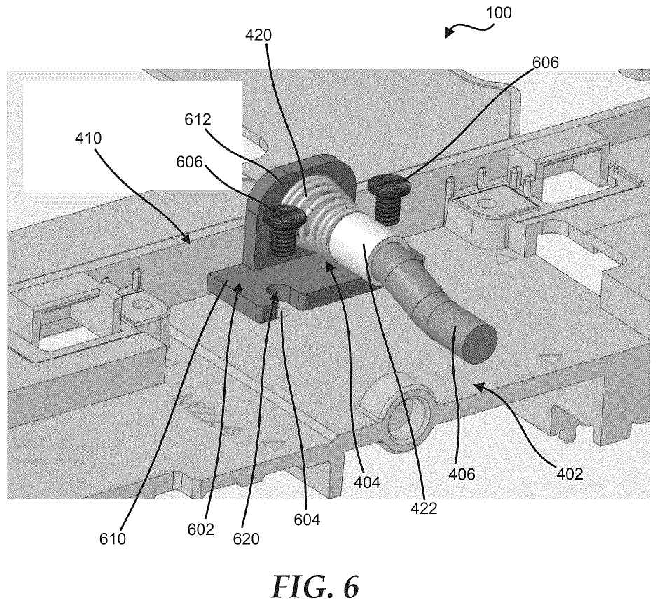

FIG. 6 illustrate a portion of information handling system 100 according to at least one embodiment of the present disclosure. The surface of rear portion 202 is removed to show the components within these areas. Information handling system 100 includes a retention mechanism 602, multiple attachment holes 604, and multiple screws 606. Retention mechanism 602 includes a base portion 610 and an alignment portion 612. Retention mechanism 602 may be securely attached to base assembly 402 by via any suitable manner. For example, each screw 606 may be inserted through a corresponding slot 620 in base portion 610. Screws 606 are then inserted within attachment holes 604 and may be tightened until the heads of screws 606 exert a force on base portion 610 to secure retention mechanism 602 in physical communication with base assembly 402 and wall 410. In an example, when retention mechanism 602 is used, wall 410 may or may not be included in base assembly 402. This area of information handling system 100 may include additional components without varying from the scope of this disclosure.

In an example, spring 420 is positioned between alignment portion 612 and mechanical component 422 with cable 406 extending through the middle of the spring and a hole in the alignment portion. In an example, mechanical component 422 may be securely attached to cable 406. The location of cable 406 with respect to alignment portion 612 of retention mechanism 602 may enable the cable to slide along through the hole of the alignment portion while the cable transitions between the retracted position and the extended position. Set of tension components 404 may provide a proper amount of tension on cable 406 to prevent the cable from being pinched or otherwise damaged as described above with respect to FIGS. 4 and 5 above. For example, spring 420 may exert a force on cable 406 via mechanical component 422 to bias the cable toward the extracted position. The transition of cable 406 between the retracted position and the extended position may be substantially similar as described above with respect to FIGS. 4 and 5 above.

In an example, retention mechanism 602 may meet a serviceability preference for cable 406 and set of tension components 404. For example, in response to screws 606 being removed from attachment holes 604 and slots 620, retention mechanism 602, cable 406, spring 420 and mechanical component 422 may be removed from base assembly 402. In an example, retention mechanism 602 may enable cable 406 to remain in place while hinge up component 210 is serviced or replaced.

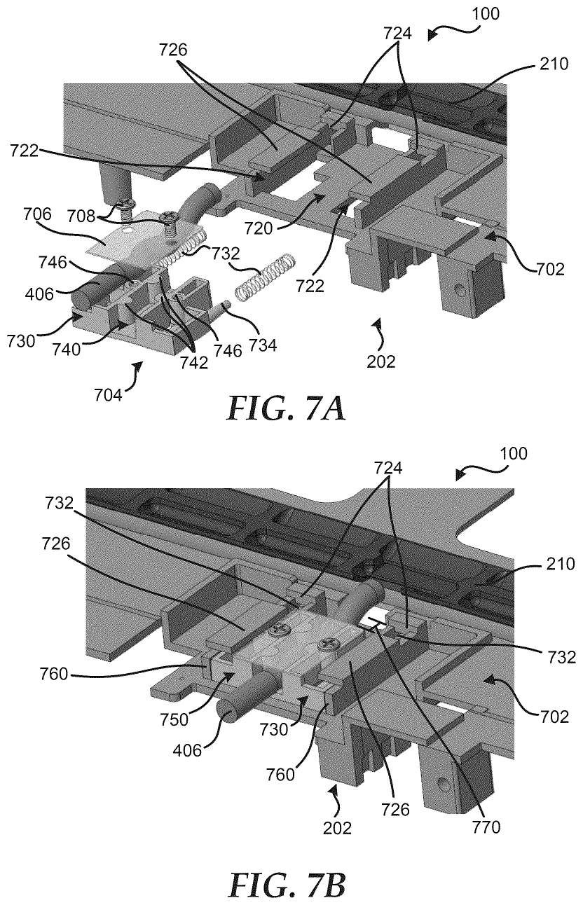

FIGS. 7A and 7B illustrate a portion of information handling system 100 according to at least one embodiment of the present disclosure. In FIGS. 7A and 7B, the surface of rear portion 202 has been removed to show the components within this area. Information handling system 100 includes a base assembly 702, a set of tension components 704, a cover 706, multiple screws 708, and cable 406. Base assembly 702 includes a tray slot 720, which in turn includes channels 722, support walls 724, and retaining components 726. Set of tension components 704 includes a mechanical component 730 and multiple springs 732. Mechanical component 730 includes a channel 740, multiple bump portions 742, posts 744, and holes 746. This area of information handling system 100 may include additional components without varying from the scope of this disclosure.

Referring to FIG. 7A, set of tension components 704 are shown in an exploded view. In an example, cable 406 may be secured to mechanical component 730 via any suitable manner. For example, cable 406 may be inserted within channel 740 and cover 706 may be attached to the mechanical component to prevent the cable from being lifted out. Cover 706 may be attached to mechanical component 730 via screws 708 and attachment holes 746. In an example, bump portions 742 may change the direction of cable 406 within channel 740, and the changes of direction may apply different forces on the cable to prevent the cable from sliding with respect to mechanical component 730.

In certain examples, mechanical component 730 may be a sliding tray or similar device. In an example, springs 732 of set of tension components 704 may be compression springs, such that the default or resting positions of the springs are to be extended as shown in FIG. 7A. Based on the structure of springs 732, the springs may provide a retraction force over the required length of travel of cable 406. Springs 732 may be positioned between support walls 724 and mechanical component 730 with posts 744 extending through the middle of the springs. In an example, mechanical component 730 may be securely attached to cable 406 as described above. Mechanical component 730 may be attached to cable 406 in a particular location that enables springs 732 to exert a force on the cable, through the mechanical component, and bias the cable toward the retracted position.

In an example, mechanical component 730 may slide within tray slot to enable cable 406 to transition between the retracted position and the extended position. Cable 406 may also extend along hinge up component 210 and be inserted into a top portion of information handling system 100. When cable 406 is in the retracted position, a minimal amount of the cable is located between base assembly 702 and hinge up component 210. In an example, this minimal amount of cable 406 may prevent the cable from being pinched between hinge up component 210 and the components of rear section 202 when a top portion is in the closed position.

Referring to FIG. 7B, cable 406 is in the retracted position. When cable 406 is in the retracted position, a back surface 750 of mechanical component 730 may be substantially aligned with a back surface 760 of tray slot 720 and a gap 770 may exist between the mechanical component and a wall of base assembly 702. Gap 770 may be an amount of travel mechanical component 730 may move during a transition of cable 406 from the retracted position to the extended position. In an example, retaining components 726 may hold mechanical component 730 within channels 722 of tray slot 720.

As a top portion of information handling system 100, transitions from a closed position to an open position, the top portion may exert a force on cable 406 to pull one end of cable away from support walls 724 of base assembly 702. As cable 406 is pulled by the top portion, mechanical component 730 may be pulled toward support walls 724. In an example, the force exerted on cable 406 by the top portion should be greater than the force exerted on the cable by springs 732 so that mechanical component 730 may be pulled toward support walls 724. The larger force exerted by the top portion may cause springs 732 to compress.

In an example, the location of mechanical component 730 may enable cable 406 to extend a proper amount from the retracted position to the extended position. This proper amount may be any suitable amount that enables the top portion to be placed in the open position but prevents cable 406 from sagging towards hinge up component 210. In an example, this amount of cable 406 being extended may prevent the cable from being pinched when the top portion is closed.

In certain examples, as the top portion rotates or transitions from the open position to the closed position, springs 732 may exert a force on cable 406 via mechanical component 730. This force exerted by springs 732 on cable 406 may ensure that the cable is maintained in a tight state, such that the cable does not sag while the top portion transitions from the open position to the closed position. In an example, the force exerted by springs 732 may prevent cable 406 from being pinched or otherwise damaged between hinge up component 210 and base assembly 702.

FIG. 8 shows a generalized embodiment of an information handling system 800 according to an embodiment of the present disclosure. Information handling system 800 may be substantially similar to information handling system 100 of FIG. 1. Further, information handling system 800 can include processing resources for executing machine-executable code, such as a central processing unit (CPU), a programmable logic array (PLA), an embedded device such as a System-on-a-Chip (SoC), or other control logic hardware. Information handling system 800 can also include one or more computer-readable medium for storing machine-executable code, such as software or data. Additional components of information handling system 800 can include one or more storage devices that can store machine-executable code, one or more communications ports for communicating with external devices, and various input and output (I/O) devices, such as a keyboard, a mouse, and a video display. Information handling system 800 can also include one or more buses operable to transmit information between the various hardware components.

Information handling system 800 can include devices or modules that embody one or more of the devices or modules described below and operates to perform one or more of the methods described below. Information handling system 800 includes a processors 802 and 804, an input/output (I/O) interface 810, memories 820 and 825, a graphics interface 830, a basic input and output system/universal extensible firmware interface (BIOS/UEFI) module 840, a disk controller 850, a hard disk drive (HDD) 854, an optical disk drive (ODD) 856, a disk emulator 860 connected to an external solid state drive (SSD) 864, an I/O bridge 870, one or more add-on resources 874, a trusted platform module (TPM) 876, a network interface 880, a management device 890, and a power supply 895. Processors 802 and 804, I/O interface 810, memory 820, graphics interface 830, BIOS/UEFI module 840, disk controller 850, HDD 854, ODD 856, disk emulator 860, SSD 864, I/O bridge 870, add-on resources 874, TPM 876, and network interface 880 operate together to provide a host environment of information handling system 800 that operates to provide the data processing functionality of the information handling system. The host environment operates to execute machine-executable code, including platform BIOS/UEFI code, device firmware, operating system code, applications, programs, and the like, to perform the data processing tasks associated with information handling system 800.

In the host environment, processor 802 is connected to I/O interface 810 via processor interface 806, and processor 804 is connected to the I/O interface via processor interface 808. Memory 820 is connected to processor 802 via a memory interface 822. Memory 825 is connected to processor 804 via a memory interface 827. Graphics interface 830 is connected to I/O interface 810 via a graphics interface 832 and provides a video display output 836 to a video display 834. In a particular embodiment, information handling system 800 includes separate memories that are dedicated to each of processors 802 and 804 via separate memory interfaces. An example of memories 820 and 830 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 840, disk controller 850, and I/O bridge 870 are connected to I/O interface 810 via an I/O channel 812. An example of I/O channel 812 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 810 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 840 includes BIOS/UEFI code operable to detect resources within information handling system 800, to provide drivers for the resources, initialize the resources, and access the resources. BIOS/UEFI module 840 includes code that operates to detect resources within information handling system 800, to provide drivers for the resources, to initialize the resources, and to access the resources.

Disk controller 850 includes a disk interface 852 that connects the disk controller to HDD 854, to ODD 856, and to disk emulator 860. An example of disk interface 852 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 860 permits SSD 864 to be connected to information handling system 800 via an external interface 862. An example of external interface 862 includes a USB interface, an IEEE 4394 (Firewire) interface, a proprietary interface, or a combination thereof. Alternatively, solid-state drive 864 can be disposed within information handling system 800.

I/O bridge 870 includes a peripheral interface 872 that connects the I/O bridge to add-on resource 874, to TPM 876, and to network interface 880. Peripheral interface 872 can be the same type of interface as I/O channel 812 or can be a different type of interface. As such, I/O bridge 870 extends the capacity of I/O channel 812 when peripheral interface 872 and the I/O channel are of the same type, and the I/O bridge translates information from a format suitable to the I/O channel to a format suitable to the peripheral channel 872 when they are of a different type. Add-on resource 874 can include a data storage system, an additional graphics interface, a network interface card (NIC), a sound/video processing card, another add-on resource, or a combination thereof. Add-on resource 874 can be on a main circuit board, on separate circuit board or add-in card disposed within information handling system 800, a device that is external to the information handling system, or a combination thereof.

Network interface 880 represents a NIC disposed within information handling system 800, on a main circuit board of the information handling system, integrated onto another component such as I/O interface 810, in another suitable location, or a combination thereof. Network interface device 880 includes network channels 882 and 884 that provide interfaces to devices that are external to information handling system 800. In a particular embodiment, network channels 882 and 884 are of a different type than peripheral channel 872 and network interface 880 translates information from a format suitable to the peripheral channel to a format suitable to external devices. An example of network channels 882 and 884 includes InfiniBand channels, Fibre Channel channels, Gigabit Ethernet channels, proprietary channel architectures, or a combination thereof. Network channels 882 and 884 can be connected to external network resources (not illustrated). The network resource can include another information handling system, a data storage system, another network, a grid management system, another suitable resource, or a combination thereof.

Management device 890 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 800. In particular, management device 890 is connected to various components of the host environment via various internal communication interfaces, such as a Low Pin Count (LPC) interface, an Inter-Integrated-Circuit (I²C) interface, a PCIe interface, or the like, to provide an out-of-band (OOB) mechanism to retrieve information related to the operation of the host environment, to provide BIOS/UEFI or system firmware updates, to manage non-processing components of information handling system 800, such as system cooling fans and power supplies. Management device 890 can include a network connection to an external management system, and the management device can communicate with the management system to report status information for information handling system 800, to receive BIOS/UEFI or system firmware updates, or to perform other task for managing and controlling the operation of information handling system 800.

Management device 890 can operate off of a separate power plane from the components of the host environment so that the management device receives power to manage information handling system 800 when the information handling system is otherwise shut down. An example of management device 890 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 890 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a top portion including a display device;
a bottom portion coupled to the top portion, the bottom portion including a processor and a base assembly;
a cable to electrically couple the display device to the processor; and
a set of cable tension components physically coupled to the base assembly, the set of cable tension components including:
a mechanical component securely attached to the cable; and
a spring to exert a first force on the mechanical component, when the top portion is in a closed position, the first force on the mechanical component to bias the cable toward a retracted position.

2. The information handling system of claim 1, wherein the set of cable tension components further includes a retention mechanism to guide the cable during a transition between the retracted and extended positions.

3. The information handling system of claim 1, wherein a portion of the cable is securely attached within the top portion.

4. The information handling system of claim 3, when the top portion is in an open position, the top portion exerts a second force on the cable to pull the cable towards an extended position, wherein the second force is greater than the first force.

5. The information handling system of claim 1, wherein the mechanical component includes a channel and a plurality of bump portions extending into the channel, wherein the bump portions securely hold the cable within the channel.

6. The information handling system of claim 5, wherein the mechanical component includes a post that extends within the spring to hold the spring in physical contact with the mechanical component.

7. The information handling system of claim 5, wherein the mechanical component slides within first and second channels of the base assembly as the cable transitions between the retracted position and the extended position.

8. The information handling system of claim 1, wherein the mechanical component is located further from a wall of the base assembly when the cable is in the retracted position as compared to when the cable is in an extended position.

9. The information handling system of claim 1, wherein the cable extends through a middle of the spring.

10. An information handling system comprising:
a top portion including a display device;
a bottom portion coupled to the top portion, the bottom portion including a processor and a base assembly;
a cable to electrically couple the display device to the processor, the cable is securely attached to the top portion, the cable to bend around a rotation axis when the top portion is an open position; and
a set of cable tension components physically coupled to the base assembly, the set of cable tension components including:
a mechanical component securely attached to the cable; and
a spring to exert a first force on the mechanical component, when the top portion is in a closed position, the first force on the mechanical component to bias the cable toward a retracted position.

11. The information handling system of claim 10, when the top portion is in the open position, the top portion exerts a second force on the cable to pull the cable towards an extended position, wherein the second force is greater than the first force.

12. The information handling system of claim 11, wherein the set of cable tension components further includes a retention mechanism to guide the cable during a transition between the retracted and extended positions.

13. The information handling system of claim 10, wherein the mechanical component includes a channel and a plurality of bump portions extending into the channel, wherein the bump portions securely hold the cable within the channel.

14. The information handling system of claim 13, wherein the mechanical component includes a post that extends within the spring to hold the spring in physical contact with the mechanical component.

15. The information handling system of claim 14, wherein the mechanical component slides within first and second channels of the base assembly as the cable transitions between the retracted position and the extended position.

16. The information handling system of claim 10, wherein the mechanical component is located further from a wall of the base assembly when the cable is in the retracted position as compared to when the cable is in an extended position.

17. The information handling system of claim 10, wherein the cable extends through a middle of the spring.

18. An information handling system comprising:
a top portion including a display device;
a bottom portion coupled to the top portion, the bottom portion including a processor and a base assembly;
a cable to electrically couple the display device to the processor, the cable is securely attached to the top portion, the cable to bend around a rotation axis when the top portion is an open position; and
a set of cable tension components physically coupled to the base assembly, the set of cable tension components including:
a mechanical component securely attached to the cable; and
a spring to exert a first force on the mechanical component, when the top portion is in a closed position, the first force on the mechanical component to bias the cable toward a retracted position, when the top portion rotates from the open position to the closed position, the spring pushes the cable from an extended position to the retracted position.

19. The information handling system of claim 18, when the top portion is in the open position, the top portion exerts a second force on the cable to pull the cable towards the extended position, wherein the second force is greater than the first force.

20. The information handling system of claim 18, wherein the set of cable tension components further includes a retention mechanism to guide the cable during a transition between the retracted and extended positions.
